(19) United States
(12) Patent Application Publication
(10) Pub. No.: US 2026/0012227 A1
(43) Pub. Date: Jan. 8, 2026

(54) DISTRIBUTED CONFIGURATION OF RIS SWARM

(71) Applicant: NEC Laboratories Europe GmbH, Heidelberg (DE)

(72) Inventors: Antonio ALBANESE, Heidelberg (DE); Placido MURSIA, Heidelberg (DE); Vincenzo SCIANCALEPORE, Heidelberg (DE); Xavier COSTA-PÉREZ, Heidelberg (DE)

(21) Appl. No.: 18/998,142

(22) PCT Filed: Oct. 25, 2022
(86) PCT No.: PCT/EP2022/079796

§ 371 Date: Jan. 24, 2025

(30) Foreign Application Priority Data
Jul. 29, 2022 (EP) 22187848

(51) Int. Cl. H04B 7/04; H04B 17/309; H04L 5/00; H04W 8/00

(52) U.S. Cl. CPC H04B 7/04013; H04B 17/346; H04L 5/0053; H04W 8/005

(57) ABSTRACT

A method for configuring distributed RIS modules in a network includes performing, by a first RIS module already deployed in the network and provided with a given phase shift configuration, a discovery process for discovering at least one second RIS module, which is a nearby RIS module that is newly deployed and not yet included in the network. The discovery process is executed using short-range communication modules implemented on the first and the at least one second RIS modules. The first RIS module determines a relative position difference to the second RIS module based on information derived from communication with the second RIS module via the short-range communication modules. The first RIS module calculates a phase shift configuration for the second RIS module according to a selected objective function based on the given phase shift configuration and based on the determined relative position difference.

### CROSS REFERENCE TO RELATED APPLICATIONS

This application is a U.S. National Phase application under 35 U.S.C. § 371 of International Application No. PCT/EP2022/079796, filed on Oct. 25, 2022, and claims benefit to European Patent Application No. EP 22187848.1, filed on Jul. 29, 2022. The International Application was published in English on Feb. 1, 2024 as WO 2024/022600 A1 under PCT Article 21(2).

### FIELD

The present invention relates to a RIS module and to a method for configuring distributed RIS modules in a network.

### BACKGROUND

Reconfigurable Intelligent Surfaces (RISs) are widely considered as one of the key technologies for next generation wireless systems, thanks to their unique ability to control the radio channel in a nearly passive way. By suitably optimizing the configuration of each RIS unit cell, the overall array can re-focus the incoming energy from the transmitter towards a specific receiver location in space while minimizing leakage towards undesired directions.

RISs are easy to manufacture, install, transport, and cheap to sell. Hence, from a market perspective, they are expected to be sold as standalone modules, each equipped with a RIS controller (RISC), which is in charge of communicating with the rest of the network for optimization reasons and/or simply enforcing the RIS configuration. Therefore, each RIS module is expected to have access to a control channel with the rest of the network (cf. V. Croisfelt, F. Saggese, I. Leyva-Mayorga, R. Kotaba, G. Gradoni, P. Popovski, “A Random Access Protocol for RIS-Aided Wireless Communications”, accepted for publication at IEEE SPAWC, 2022. Online: https://arxiv.org/abs/2203.03377).

However, due to the fast growing demands of beyond 5G wireless networks, the number of RISs to meet quality of service (QOS) constraints may increase over time, pushing operators to increase the number of deployed RISs. Conventional RIS network architectures may thus become unpractical since they comprise all such modules being connected via a control channel to the rest of the network, increasing the overall overhead and complexity of the system.

State-of-the-art RIS control methods perform strict synchronization between the base station (BS) and the RISC in order to optimize the phase-shift configuration, perform channel estimation, and random access procedures (cf. G. T. de Araújo, and A. L. F. de Almeida, “PARAFAC-Based Channel Estimation for Intelligent Reflective Surface Assisted MIMO System,” in Proceedings of IEE SAM, Hangzhou, China, June 2020). Such approaches do not allow to increase the number of deployed RISs and/or their position without having to modify the control channel implementation to support newly deployed RISs.

In this context, self-configuring RISs have been proposed to allow RIS operation in the absence of a control channel (for reference, see A. Albanese, F. Devoti, V. Sciancalepore, M. Di Renzo, and X. Costa-Pérez, “MARISA: A Self-configuring Metasurfaces Absorption and Reflection Solution Towards 6G”, accepted for publication in IEEE INFOCOM 2022, [Online]: http://arxiv.org/abs/2112.01949, or

PCT/EP 2021/082525, not yet published). By implementing power-based indirect beamforming, RISs can perform indirect sensing of the angle-of-arrival (AoA), which in turn enable estimating the base station (BS)-RIS and RIS-User Equipment (UE) channels with little local information. However, this approach might lead to suboptimal sum-rate performance in high mobility conditions, e.g., in vehicular network scenarios. Moreover, the overhead introduced by the probing phase for self-configuration might overcome its advantage in terms of deployment flexibility when compared to centralized deployments whose overhead depends mostly on channel estimation and reporting over the control channel.

The authors of S. Gopi, S. Kalyani and L. Hanzo, “Intelligent Reflecting Surface Assisted Beam Index-Modulation for Millimeter Wave Communication,” in IEEE Transactions on Wireless Communications, vol. 20, no. 2, pp. 983-996, February 2021, doi: 10.1109/TWC.2020.3029743 disclose a system to construct a low-cost beam-index modulation scheme that enables two-hop RIS-based communication by propagating the configuration of the second RIS through the first RIS in parallel to the transmit signal. Although this work involves multiple RISs, it still may require centralized control of all RISs.

### SUMMARY

In an embodiment, the present disclosure provides a method for configuring distributed RIS modules in a network. The method comprises: performing, by a first RIS module already deployed in the network and provided with a given phase shift configuration, a discovery process for discovering at least one second RIS module, which is a nearby RIS module that is newly deployed and not yet included in the network, wherein the discovery process is executed using short-range communication modules implemented on the first and the at least one second RIS modules; determining, by the first RIS module based on information derived from communication with the second RIS module via the short-range communication modules, a relative position difference to the second RIS module; and calculating, by the first RIS module based on the given phase shift configuration and based on the determined relative position difference, a phase shift configuration for the second RIS module according to a selected objective function.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view illustrating a standalone RIS board, equipped with a RISC and a PCM module, in accordance with an embodiment;

FIG. 2 is a schematic view illustrating a RIS master-slave architecture in accordance with an embodiment; and

FIG. 3 is a schematic view illustrating the concept of automatic configuration of a RIS swarm in accordance with an embodiment.

### DETAILED DESCRIPTION

In accordance with an embodiment, the present invention improves and further develops a RIS module and a method for configuring distributed RIS modules in a network in such a way that automatic RISs configurations in a distributed and transparent manner are enabled, without requiring modifying existing configurations.

In accordance with another embodiment, the present invention provides a method for configuring distributed RIS modules in a network, the method comprising: performing, by a first RIS module, which is a RIS module already deployed in the network and provided with a given phase shift configuration, a discovery process for discovering at least one second RIS module, which is a nearby RIS module that is newly deployed and not yet included in the network, wherein the discovery process is executed using short-range communication modules implemented on the RIS modules; determining, by the first RIS module based on information derived from the communication with the second RIS module via the short-range communication modules, the relative position difference to the second RIS module; and calculating, by the first RIS module based on its own phase shift configuration and based on the determined relative position difference, a phase shift configuration for the second RIS module according to a selected objective function.

Furthermore, in accordance with another embodiment, the present invention provides a RIS module, comprising: a control element; an array of reflective elements, wherein each reflective element comprises an antenna element and a phase shifter and is under control of the control element so as to reflect a radio-frequency, RF, signal incident on the reflective element with an adjustable phase shift realized by the phase shifter; and a short-range communication module; wherein the control element is configured to cause the RIS module to provide for the execution of the steps of: performing a discovery process for discovering another RIS module, which is a newly deployed RIS module, nearby, wherein the discovery process is executed using the short-range communication module; determining, based on information derived from the communication with the other RIS module via the short-range communication module, the relative position difference to the other RIS module; and calculating, based on the RIS module's own phase shift configuration and based on the determined relative position difference, a phase shift configuration for the other RIS module according to a selected objective function.

According to the invention, it has been recognized that current RIS designs do not consider solutions to deploy additional RIS modules into existing deployments. Indeed, they might require the operator to modify the control channel configuration to support any new RIS modules or rely on self-configuring RISs. Embodiments of the present invention address the challenge of brownfield RIS deployments, whereby, if desired, e.g. by reason of changing customer needs, additional RISs may be automatically configured in a transparent manner and in a distributed fashion, without requiring modifying existing configurations.

Embodiments disclosed herein provide methods for autonomously configuring distributed RIS modules with a single control channel. This is possible by endowing each RIS module with low-power, low-complexity short-range communication capabilities, which may be exploited to share local channel state information, and optimizing the RIS configurations to suitably compensate for the relative position differences between different modules in the angular domain. More specifically, embodiments disclosed herein provide a solution that consists in leveraging on one or more deployed RIS modules, which are already connected to a network, e.g. a base station BS, via any existing prior art control architecture, to act as decentralized controllers. Whenever one or more new RISs are placed in the environment, they will be discovered by the existing RISs via proximity technologies, i.e. the RIS's short-range communication module (herein sometimes referred to as ‘proximity communication module’, PCM) provided in accordance with embodiments of the present invention. Furthermore, in accordance with embodiments disclosed herein, such newly deployed RIS will be automatically configured by exploiting the knowledge of the relative position of the new RIS with respect to the others in the environment. The control element of such RISs (RIS controller, RISC) may then derive the phase-shifting matrix of the new RIS as a by-product of the one currently used and communicated by the BS via the existing control architecture. Embodiments disclosed herein enable a smooth deployment of additional RISs in an existing network in a transparent way, without having to modify neither an existing configurations nor a currently applied control protocol

According to an embodiment, the first RIS module, i.e. a RIS module already deployed in the network and provided with a given phase shift configuration, and the second RIS module, i.e. a RIS module newly deployed in the network environment, form a master-slave configuration. In other words, the two RIS modules build a master-slave-couple, in which the second RIS module is associated to the first RIS module and receives its phase shift configuration from the first RIS module. A control link between the two RIS modules may established via the modules' short-range communication modules. The control link may be used both for establishing an association between the two modules, as will be described in detail below, and for performing the phase shift configuration, i.e. to exchange respective configuration messages.

According to embodiments, different objective functions may be implemented at the first (or master) RIS module. For instance, the objective function may aim at maximizing a signal-to-noise-ratio, SNR, at a (single) intended receiver location or minimizing cross-interference and/or increasing a multicast rate in the case of a multi-user scenario. Other possible objective functions include the multicast rate, fairness, system sum rate, etc., which all result in different master-slave configurations.

According to an embodiment, the first RIS module may be configured to calculate the phase shift configuration for the second RIS module in such a way that radio-frequency, RF, signals reflected upon the second RIS module are coherently summed up with its own reflected RF signals at an intended receiver. In this case, from the viewpoint of the intended receiver, the two RISs would be seen effectively as a single surface with double the number of reflective elements.

According to an embodiment, in case of a plurality of already deployed RIS modules and a plurality of newly deployed RIS modules, it may be provided that the configuration of the newly deployed RISs is obtained as a shifted version in the angular domain of the configuration of the already deployed RIS modules. Such angular shift may depend on the relative position difference between the new and deployed modules and on the chosen optimization objective (i.e. the applied objective function).

According to an embodiment, it may be provided that the first RIS module, in case of discovering a plurality of newly deployed RIS modules, executes an association procedure configured to select, from the plurality of newly deployed RIS modules, one or more RIS modules for association, in particular for establishing a master-slave configuration with the selected RIS modules.

In the context of this association procedure, it may be provided that the newly deployed RIS modules are configured to transmit, via their short-range communication modules, self-announcing broadcast messages, which will be received by pre-deployed RIS modules located in their vicinity. The self-announcing broadcast messages may contain communication-related information about the respective RIS modules, for instance information about their position and/or their number of passive antenna elements. Upon receipt of a self-announcing broadcast message from a newly deployed RIS module by a pre-deployed and configured RIS module, this RIS module may acknowledge the received broadcast message by transmitting, likewise via its short-range communication module, a respective acknowledgment message.

According to an embodiment, in the context of the association procedure, it may be further provided that each of a plurality of newly deployed RIS modules determines the signal strength of its received acknowledgment messages. Based thereupon, each newly deployed RIS module may associate to the one of the already deployed RIS modules from which the acknowledgment message with the highest signal strength was received. On the one hand, such configuration ensures a high stability of the control link (over the RISs' short-range communication modules). On the other hand, it ensures a closer vicinity of the master-slave couple, which results in more accurate configuration of the slave RIS as the wireless channels seen by the two RISs are likely to be more similar.

According to an embodiment, in the context of the association procedure, it may be further provided that the already deployed RIS modules monitor the number of newly deployed RIS modules to which they have already established an association. Upon determining by an already deployed RIS module that the number of associated newly deployed RIS modules has reached a maximum number, such already deployed RIS module may cease to transmit acknowledgment messages responsive to any new broadcast messages received from the plurality of newly deployed RIS modules. In this way, overloading of the already deployed RIS modules can be effectively prevented.

According to an embodiment, the short-range communication modules may be configured to include an NFC (Near Field Communication) module embedded into the RIS board. Depending on the requirements, two or more short-range communication modules may be arranged on the RIS board of the RIS modules. For instance, multiple communication modules per RIS board (e.g. located on opposite sides of the board) may be useful to enable stable communication in all directions, i.e. not restricted to any angular span.

According to an embodiment, the control element of the RIS modules may be configured to communicate with a base station of a network via a control channel for setting a desired RIS phase-shift configuration. Generally, the control element of the RIS modules may include one or more processors and a memory storing instructions, wherein the instructions when executed by the one or more processors cause the control element to execute the protocols or tasks disclosed herein, in particular with respect to the calculation of the face of configuration for newly deployed RIS modules. For instance, in accordance with an embodiment, the control element of a pre-deployed RIS module may be configured to calculate the phase shift configuration for a newly deployed RIS module (associated with the pre-deployed RIS module) in such a way that, at an intended receiver, RF signals reflected upon the newly deployed RIS module are coherently summed up with the RF signals reflected upon the pre-deployed RIS module.

There are several ways how to design and further develop the teaching of the present invention in an advantageous way. To this end, it is to be referred to the dependent claims on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will be explained. In the drawing

Reflective devices known as Reconfigurable Intelligent Surfaces (RISs), sometimes also referred to as Intelligent Reconfigurable Surface (IRS), are one of the most promising disrupting technologies for the upcoming cellular network generations. In short, RIS are radio-frequency (RF) reflectors whose response to impinging signals is programmable from a centralized controller. In particular, their ability to backscatter or phase-shift the impinging electromagnetic waves makes the wireless radio channel a variable to be optimized rather than a black box to be mitigated.

A Reconfigurable Intelligent Surface (RIS) is essentially a planar structure with passive reflective cells (unit cells) that can control the electromagnetic response of impinging radio-frequency (RF) signals, such as changes in phase, amplitude, or polarization. Indeed, RISs open up a new paradigm where the wireless channel—traditionally treated simply as an optimization constraint—plays an active role subject to optimization with the potential of increasing the energy efficiency of mobile networks by >50%.

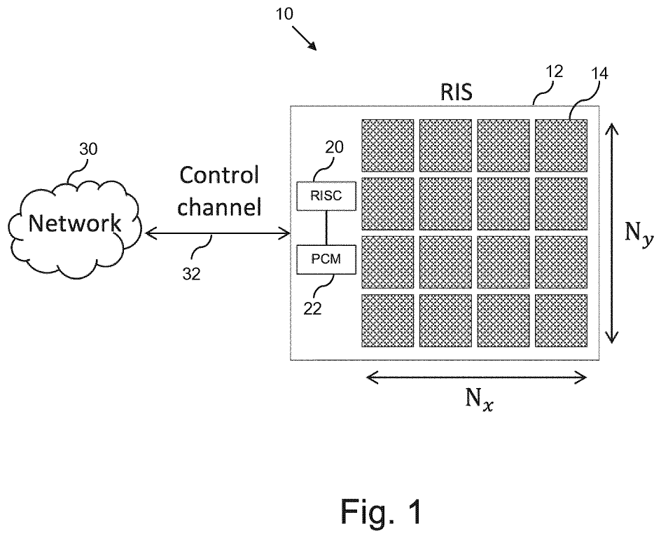

FIG. 1 is a schematic view illustrating the basic RIS concept according to an embodiment. According to this concept, a RIS module 10 comprises a board 12 including an array of N=Nₓ×N_{y} reflective elements or unit cells 14 (both terms are sometimes used interchangeably in the present disclosure), wherein Nₓ and N_{y} are the number of unit cells 14 along the x- and y-axis of the board 12, respectively. Each unit cell 14 includes a passive antenna element and a phase shifter (both not explicitly shown). The RIS module 10 is under control of a local control element—RIS controller (RISC) 20—that communicates directly to the phase shifters on the unit cells 14 and is in charge of setting a desired RIS phase-shift configuration.

In a conventional RIS hardware standalone module according to prior art, the RISC 20 of the module is typically further configured to communicate with the rest of the network 30 via a control channel 32. Unlike such existing RIS hardware, embodiments of the present disclosure provide RIS modules 10 that comprise an additional component, namely a short-range communication module, herein sometimes denoted proximity communication module (PCM) 22, as exemplarily shown in FIG. 1. The PCM is a device capable of (low-power) short communications with other RIS boards in close range. According to an embodiment, one possible implementation of the PCM is represented by an NFC module (see, for instance, https://www.nxp.com/products/product-selector:PRODUCT-SELECTOR #/category/c817_c798_c1491).

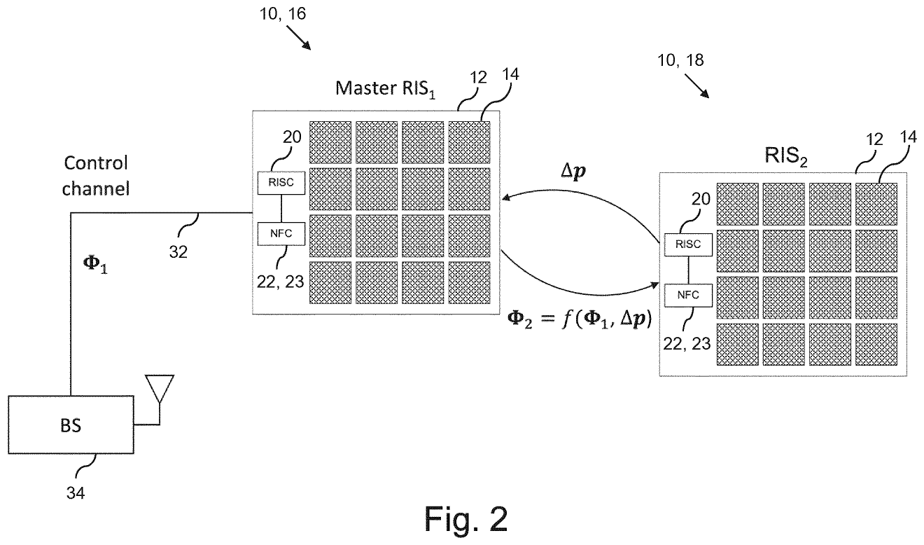

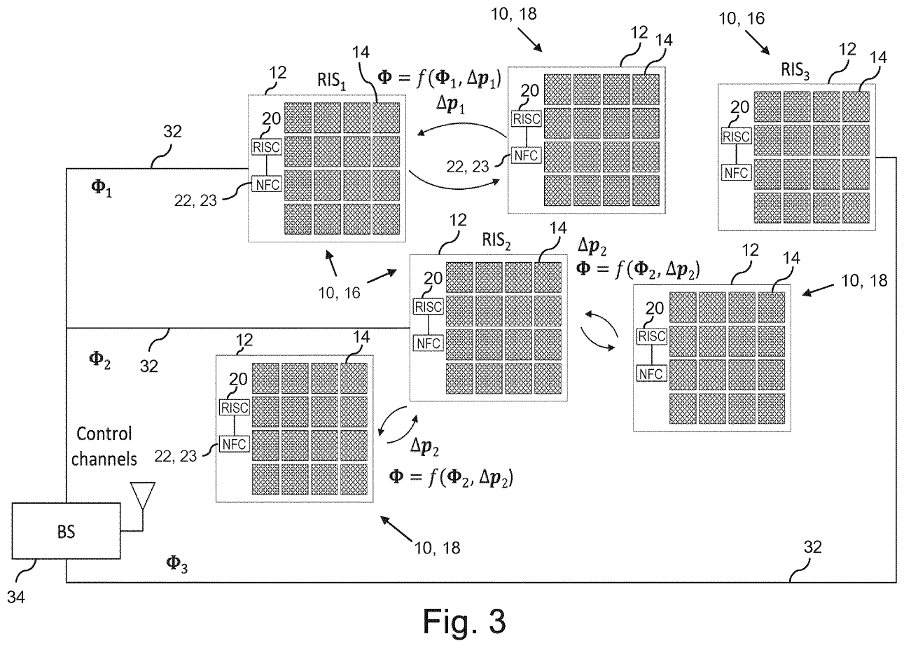

As will be described in detail with reference to FIGS. 2 and 3, according to embodiments, the PCM may be used in the context of a novel framework for automatic configuration of any additional RIS modules, based solely on the known configuration of the RISs 10 that are already connected to the control channel 32, the position of the respective base station, BS, and local information available through the PCM 22.

### Proximity Discovery Via NFC and Master-Slave Configuration

As an illustrative example depicted in FIG. 2, one may consider the case of an existing deployment with a RIS module 10, denoted RIS₁, to which one additional RIS 10, namely RIS₂, has been added.

Without loss of generality, it may be assumed that the phase-shift configuration matrix of RIS module RIS₁, denoted Φ₁ herein, has been optimized a-priori using any existing prior art technique (e.g., the technique described in P. Mursia, V. Sciancalepore, A. Garcia-Saavedra, L. Cottatellucci, X. C. Pérez and D. Gesbert, “RISMA: Reconfigurable Intelligent Surfaces Enabling Beamforming for IoT Massive Access,” in IEEE Journal on Selected Areas in Communications, vol. 39, no. 4, pp. 1072-1085. April 2021, doi: 10.1109/JSAC.2020.3018829, the entire disclosure of which is hereby incorporated by reference herein). Such RIS 10 is then elected to act as a master RIS 16 over the newly added RIS module RIS₂ that, correspondingly, acts as a slave RIS 18. Generally, master RISs are configured and managed by the network, while, on the other hand, slave RISs are not connected to the network control channel, but are managed separately by their associated master RIS. According to embodiments of the present disclosure, it may be provided that, whenever any given RIS is connected to the network (i.e., it communicates with a BS 34 of the network and it is configured by the network), then it automatically knows that it needs to behave as a master RIS 16 (i.e. to discover any new RISs 18 and coordinate with existing master RISs 16).

Starting from this situation, the goal is to find, with the location information available at the master RIS 16, the phase-shift configuration Φ₂ for RIS₂, i.e. slave RIS 18. According to embodiments, using the PCM 22, depicted as NFC module 23 in the implementation of FIG. 2, the master RIS 16 can estimate the difference in position, denoted Δp, with respect to RIS₂. Based on this and in addition with the knowledge of the position of the BS 34 (which can be assumed to be known) and an intended receiver location, which can be inferred from the known configuration matrix Φ₁, according to an embodiment the RISC 20 at the master RIS 16 may derive the configuration matrix Φ₂ according to a pre-defined or configurable objective function. For instance, the RISC 20 at the master RIS 16 may be configured to determine the configuration matrix Φ₂ in such a way that a signal reflected upon RIS₂ is coherently summed up at the intended receiver with the signal reflected upon the master RIS 16.

At this stage and depending on the chosen objective function, the two RISs, i.e. pre-deployed RIS₁ and newly added RIS₂, may be seen effectively either as a single surface with double the number of elements, or as two separate RISs with different purposes. Indeed, if the objective function is, e.g., to reduce the signal-to-noise-ratio (SNR) at the (single) intended receiver location, then the BS 34 may see the two RISs 16, 18 as a single surface. On the other hand, in the case of a multi-user scenario, the two RISs 16, 18 may be configured to passively steer the incoming signals towards two different locations, while minimizing cross-interference. Other possible objective functions include the multicast rate, fairness, system sum rate, etc., which all result in different master-slave configurations.

Furthermore, it should be noted that if there is any channel estimation procedure in place, the newly deployed slave RIS 18 will be implicitly discovered by the BS 34 and seen as a high-power propagation path. Hence, the BS 34 will configure its transmission strategy by adding the direction of the slave RIS 18 in an implicit way, without having any knowledge of its presence.

### Distributed Configuration of RIS Swarms

As shown in FIG. 3, where like reference number denote like or similar components as in FIG. 2, embodiments of the present disclosure generalize the proposed method for the case of RIS swarms, i.e., a distributed deployment of a large number of RIS boards 12.

In this case, without loss of generality, it can be assumed that there is a pre-deployment scenario in which L RISs 10 are connected via a control channel 32 to a BS 34. As in the scenario of FIG. 2, the control channel 32 is used to implement and communicate optimized phase-shift configurations {Φ₁}ₗ₌₁^{L} for the deployed RISs 10. In the embodiment exemplarily depicted in FIG. 3, the pre-deployment scenario includes three RISs 10, denoted RIS₁, RIS₂, and RIS₃, i.e. L=3.

Embodiments of the present disclosure provide a method of distributed configuration of a plurality of new RISs (RIS swarm). According to an embodiment, as illustrated in FIG. 3, the method firstly focuses on finding a suitable association between the RISs 16 that are already connected to the BS 34 and the newly deployed RISs 18. In particular, the PCMs 22 (e.g., NFC 23) integrated in each of the RIS boards 12 are used to coordinate the association across multiple RIS boards 12, such that each new RIS 18 is assigned to only one other of the pre-deployed RISs 16 for distributed control. According to an embodiment, this association procedure may be based on the relative position difference between each RIS couple and the maximum number of connections supported by the respective PCMs 22. According to embodiments, it may be provided that the pre-deployed RISs 16 execute the association procedure periodically on a separate control channel, wherein the periodicity of the execution is a system design parameter.

According to embodiments, when introduced into an existing deployment, a new RIS 18 may be configured to announce itself by broadcasting communication-related information, e.g., its number of passive antenna elements and its position. As the already deployed RISs 16 acknowledge the announcement message, the new RIS 18 may be configured to associate to the RIS 16 whose message is received at the PCM 22 with the highest power. By doing so, the association procedure guarantees i) higher stability of the control link over PCMs 22, ii) closer vicinity of the master-slave couples. In turn, this results in a more accurate configuration of the slave RIS 18 as the wireless channels seen by the two RISs 16, 18 of a respective master-slave couple are likely to be more similar.

According to embodiments, it may be provided that when a new slave RIS 18 is associated to a master RIS 18 that already has one or more associated slave RISs 16, such slave RISs 16 may be reconfigured depending on the chosen objective function at the master RIS 18. Like in the embodiment described in connection with FIG. 2, the objective function may relate to various aspects, for instance a reduction of the signal-to-noise-ratio (SNR) at the (single) intended receiver location, or a minimization of cross-interference in case of a multi-user scenario.

According to an embodiment, the master RISs 16 may be configured to not acknowledge or reject any new broadcast messages incoming from newly deployed RISs 18 as soon as the respective master RIS 16 has reached the maximum number of associated slave RISs 18. By this configuration, overloading of the master RISs 16 can be effectively prevented.

According to embodiments, once the association between master RISs 16 and slave RISs 18 has been fixed, each RIS cluster performs the aforementioned proposed routine to optimize the phase-shifting configuration of the remaining RISs in a distributed way.

It should be noted that in both embodiments described in connection with FIG. 1 and FIG. 2, respectively, the accuracy in the estimation of each relative position difference Δₚ_{ᵢ} is one of the key parameters affecting the achievable performance of the proposed scheme. In this regard, the position on the RIS board 12 and communication capabilities of the PCM 22 may have an impact. In particular, if the chosen PCM 22 supports communication only on a restricted angular span, it may be necessary to have multiple PCMs 22 per board 12, such as on opposite sides of the RIS board 12.

Embodiments of the present invention provide the following advantages and improvements:
1. A RIS board equipped with a PCM enabling low-power and low-complexity signaling with neighboring RISs, e.g., to estimate their relative position.
2. A framework for automatic configuration of any additional number of RIS modules added to an existing deployment, without modifying the control channel, thus allowing flexible and dynamic RIS deployments that may change over time both in position and number of boards. In particular, the configuration of the new additional RISs may be obtained as a shifted version in the angular domain of the configuration of the previously deployed ones. Such angular shift may depend on the relative position difference between the new and deployed modules, and on the chosen optimization objective and KPI.

In an embodiment, the present invention provides a method automatic configuration of RIS swarms of flexible number and position, requiring only local information available at the RIS without any modification to the control channel, the method comprising one or more of the following steps:
1. Equipping the deployed and additional RISs with a PCM;
2. A given deployed RIS discovering a nearby RIS that is not yet included in the network;
3. Such given RIS estimating the relative position difference to the nearby RIS;
4. Such given RIS calculating the optimal phase shift configuration of the nearby RIS based on its own configuration, which is previously obtained via any known procedure;
5. Optionally, in case of RIS swarms, there might be an association protocol to assign each newly deployed RIS to each existing one (one by one) enabling distributed control. The association protocol may comprise the following additional steps:
   a. New RISs self-announcing to the deployed RISs and broadcasting communication-related information such as their number of passive antenna elements and position;
   b. Deployed RISs within coverage of the new RISs acknowledging the broadcast messages of the previous step 5.a.;
   c. Each new RIS associating to the deployed RIS whose message over the PCM has the highest power/signal strength among all received messages from the deployed RISs within coverage;
   d. Each deployed RIS performing step 4. for each of its assigned new RIS modules.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for configuring distributed RIS modules in a network, the method comprising:
performing, by a first RIS module already deployed in the network and provided with a given phase shift configuration, a discovery process for discovering at least one second RIS module, which is a nearby RIS module that is newly deployed and not yet included in the network, wherein the discovery process is executed using short-range communication modules implemented on the first and the second RIS modules;
determining, by the first RIS module based on information derived from communication with the second RIS module via the short-range communication modules, a relative position difference to the second RIS module; and
calculating, by the first RIS module based on the given phase shift configuration and based on the determined relative position difference, a phase shift configuration for the second RIS module according to a selected objective function.

2. The method according to claim 1, wherein the first RIS module and the second RIS module form a master-slave configuration.

3. The method according to claim 1, wherein the selected objective function aims at maximizing a signal-to-noise-ratio (SNR) at an intended receiver location or minimizing cross-interference and/or increasing a multicast rate in the case of a multi-user scenario.

4. The method according to claim 1, wherein the first RIS module calculates the phase shift configuration for the second RIS module in such a way that radio-frequency (RF) signals reflected upon the second RIS module are coherently summed up with RF signals reflected upon the first RIS module at an intended receiver.

5. The method according to any of claims 1, wherein, in case of a plurality of already deployed RIS modules and a plurality of newly deployed RIS modules, the configuration of the newly deployed RISs is obtained as a shifted version in the an angular domain of a configuration of the already deployed RIS modules.

6. The method according to claim 1, further comprising:
executing, by the first RIS module in case of discovering a plurality of newly deployed RIS modules, an association procedure configured to select, from the plurality of newly deployed RIS modules, one or more RIS modules for association.

7. The method according to claim 6, wherein the association procedure comprises:
receiving, by the first RIS module, self-announcing broadcast messages from the plurality of newly deployed RIS modules, the messages comprising communication-related information about the respective RIS modules; and
acknowledging, by the first RIS module via the short-range communication modules, the received broadcast messages by transmitting respective acknowledgment messages.

8. The method according to claim 7, wherein the association procedure further comprises:
receiving, by each of the plurality of newly deployed RIS modules via a respective short-range communication module, acknowledgment messages from a plurality of already deployed RIS modules;
determining, by each of the plurality of newly deployed RIS modules, a signal strength of the received acknowledgment messages; and
associating, by each of the plurality of newly deployed RIS modules, to the one of the already deployed RIS modules from which the acknowledgment message with a highest signal strength was received.

9. The method according to claim 6, wherein the association procedure further comprises:
monitoring, by the first RIS module, the plurality of newly deployed RIS modules associated to the first RIS module; and
upon determining, by the first RIS module, that the number of newly deployed RIS modules associated to the first RIS module has reached a maximum number, ceasing to transmit acknowledgment messages responsive to any new broadcast messages received from the plurality of newly deployed RIS modules.

10. A RIS module, comprising:
a control element;
an array of reflective elements, wherein each reflective element comprises an antenna element and a phase shifter and is under control of the control element so as to reflect a radio-frequency (RF) signal incident on the reflective element with an adjustable phase shift realized by the phase shifter; and
a short-range communication module;
wherein the control element is configured to cause the RIS module to provide for the execution of the steps of:
performing a discovery process for discovering another RIS module, which is a newly deployed RIS module nearby, wherein the discovery process is executed using the short-range communication module;
determining, based on information derived from the communication with the other RIS module via the short-range communication module, a relative position difference to the other RIS module; and
calculating, based on a phase shift configuration of the RIS module and based on the determined relative position difference, a phase shift configuration for the other RIS module according to a selected objective function.

11. The RIS module according to claim 10, wherein the short-range communication module includes an NFC module embedded into an RIS board associated with the RIS module.

12. The RIS module according to claim 10, wherein two or more short-range communication modules are arranged on the RIS board.

13. The RIS module according to claim 10, wherein the RIS module is configured to form a master-slave configuration with the other RIS module.

14. The RIS module according to claim 10, wherein the control element is configured to communicate with a base station of a network via a control channel for setting a desired RIS phase-shift configuration.

15. The RIS module according to claim 10, wherein the control element is configured to calculate the phase shift configuration for the other RIS module in such a way that radio-frequency (RF) signals reflected upon the other RIS module are coherently summed up with RF signals reflected upon the RIS module at an intended receiver.
